(19) United States
(12) Patent Application Publication
(10) Pub. No.: US 2025/0108729 A1
(43) Pub. Date: Apr. 3, 2025

(54) METHOD AND SYSTEM FOR DRIVING ASSISTANCE FOR A VEHICLE

(71) Applicant: FAURECIA Sièges d'Automobile, NANTERRE (FR)

(72) Inventors: Omar BEN ABDELAZIZ, NANTERRE (FR); Nour BESBES, MONTROUGE (FR)

(21) Appl. No.: 18/899,820

(22) Filed: Sep. 27, 2024

(30) Foreign Application Priority Data
Sep. 29, 2023 (FR) 2310416

(51) Int. Cl. B60N 2/00; B60K 35/22; B60K 35/26; B60K 35/28; B60N 2/20; B60N 2/90

(52) U.S. Cl. CPC B60N 2/0021; B60K 35/22; B60K 35/26; B60K 35/28; B60N 2/20; B60N 2/90; B60K 2360/178; B60N 2002/981

(57) ABSTRACT

The present disclosure relates to a method for driving assistance for a vehicle comprising the following steps:
initializing a counter;
detecting a first stationary posture of the occupant for a period longer than a first defined duration;
incrementing the counter by one value;
controlling the operation of the seat equipment item in an operating mode;
when a second stationary posture is detected for longer than a second defined duration, incrementing the counter by one value;
comparing the counter value with a threshold;
when the counter value equals the threshold, generating an alert signal to assist the driver.

### PRIORITY CLAIM

This application claims priority to French Patent Application No. FR2310416, filed Sep. 29, 2023, which is expressly incorporated by reference herein.

### BACKGROUND

The present disclosure relates to the field of minimizing vehicle accidents. In particular, the present disclosure relates to a method and a system for driving assistance for a vehicle

### SUMMARY

According to the present disclosure, a method for assisting the driving of a vehicle implemented by an assistance system comprising a controller, a seat, at least one sensor for detecting the movement of an occupant of the seat, and at least one seat equipment item capable of operating in a plurality of operating modes, the method comprising the following steps:
a) initializing a counter;
b) detecting a first stationary posture of the occupant for a period longer than a first defined duration;
c) incrementing the counter by one value;
d) controlling the operation of the at least one seat equipment item in an operating mode;
f) when a second stationary posture is detected for longer than a second defined duration, incrementing the counter by one value;
g) comparing the counter value with a threshold;
h) when the counter value equals the threshold, generating an alert signal to assist the driver.

Advantageously, this method warns the driver when he is experiencing a significant level of cognitive distraction, so that he can implement measures to reduce these cognitive distractions, such as stopping chatting with other passengers, turning off the radio, concentrating, etc.

The features disclosed in the following paragraphs may optionally be implemented. They can be implemented independently of one another or in combination with one another:
When the counter value is below the threshold, the method comprises the following steps:
controlling a change in the operating mode of the at least one seat equipment item and controlling the operation of the at least one seat equipment item in the changed operating mode, and
returning to step f).
The assistance system comprises a plurality of seat equipment items, and wherein when the counter value is below the threshold, the method comprises the following steps:
controlling the operation of another seat equipment item, and
returning to step f).
The at least one seat equipment item comprises at least one vibrating device comprising a support and a vibrating element movable relative to the support; and wherein the step of controlling a change in the operating mode of the vibrating device comprises changing the vibration frequency of the vibrating element and/or changing the vibration amplitude of the vibrating element and/or changing the vibration duration.

Advantageously, a vibration stimulus is an effective means of generating driver movement and mental refocusing on the driving activity.

Advantageously, this method is efficient and inexpensive.
The seat comprises a squab and a backrest hinged to the squab; and wherein the at least one seat equipment item comprises a first seat equipment item and a second seat equipment item carried by one of the backrest and squab, the first seat equipment item being disposed on one side of a central vertical plane, the second seat equipment item being disposed on the other side of the central vertical plane.
The seat comprises a squab, a backrest hinged to the squab and wherein the at least one seat equipment item comprises an actuator capable of driving the pivoting of the backrest relative to the squab, and wherein the step of controlling the operation of the at least one seat equipment item comprises a step of controlling the driving in rotation of the backrest relative to the squab through an angle of between 3% and 6% of the total angular travel of the backrest by the actuator.
The method comprises a step for determining the first defined duration based on the number of passengers in the vehicle and/or the vehicle's driving environment.
The assistance system further comprises a speaker and/or a display screen, and wherein, upon receipt of the alert signal, the method further comprises a step of displaying an alert message on the display screen and/or broadcasting an alert sound message through the speaker.

The method further comprises the following steps:
i) detecting a movement of the seat occupant after a second stationary posture is detected,
j) determining the duration between the start of operation of the at least one seat equipment item, and/or the start of operation of the other seat equipment item, and the detection of the occupant's movement;
k) generating an output signal representative of the determined duration,
l) returning to step a).

Advantageously, the determined duration D corresponds to a reaction time in relation to a stimulus. This reaction time accurately characterizes mental load according to scientific data.
The assistance system further comprises a display screen suitable for displaying images, and wherein the method further comprises a step of modifying the display parameters of the image content displayed on the display screen, when the determined duration is greater than a first limit value.
The assistance system further comprises a communication interface, a speaker and/or a display screen; the communication interface being intended to communicate with a cell phone, and wherein when the predetermined duration is greater than a second limit value, the method comprises a step of delaying the display of at least one mini-message on the display screen and/or delaying the broadcasting of at least one audio message by the speaker, the mini-message and the audio message having been received by the cell phone.
The assistance system further comprises a speaker and/or display screen, and wherein the method further comprises a step of displaying and/or audio broadcasting a value representative of the determined duration and/or counter values.

The present disclosure also relates to a system for assisting the driving of a vehicle, the system comprising a seat, at least one sensor for detecting the movement of an occupant of the seat, and at least one seat equipment item capable of operating in a plurality of operating modes and a controller (10) configured to implement the assistance method as mentioned hereinbefore.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective diagram of an assistance system according to a first embodiment of the present disclosure;

FIG. 2 is a diagram depicting the steps of the assistance method according to the present disclosure; and

FIG. 3 is a diagram depicting other steps of the assistance method according to the present disclosure.

### DETAILED DESCRIPTION

In the following disclosure, in the longitudinal direction X, a horizontal direction is understood to extend between the front and the rear of the vehicle seat. The transverse direction Y refers to a horizontal direction, extending from one side of the vehicle seat to the other side of the vehicle seat. The vertical direction Z means the direction perpendicular to the longitudinal X and transverse Y directions.

In the following disclosure, the vehicle driver is generally referred to as the “seat occupant”.

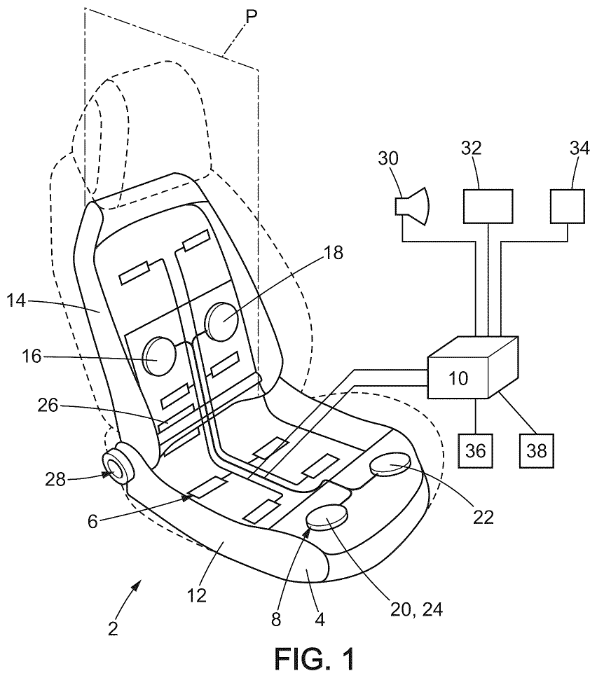

FIG. 1 shows an example of an assistance system 2 suitable for implementing the vehicle driving assistance method according to the present disclosure. In FIG. 1, the seat frame is shown as a solid line, while the trim and foam are shown as a dotted line.

In the example shown, the assistance system 2 comprises a seat 4, sensors 6 for detecting movement of a seat occupant, seat equipment items 8 capable of operating in a plurality of operating modes, a controller 10 connected to the movement detection sensors 6 and the seat equipment items 8.

The seat 4 can be a motor vehicle seat, a train seat, a truck seat, a bus seat, an airplane seat or a boat seat.

The seat 4 comprises a squab 12 and a backrest 14 which is mounted on the squab by an articulation system.

In the embodiment shown in FIG. 1 by way of example, the assistance system 2 comprises a first seat equipment item 16 and a second seat equipment item 18 carried by the backrest 14, a third seat equipment item 20 and a fourth seat equipment item 22 carried by the squab 12. The first seat equipment item 18 is arranged on one side of a central vertical plane P. The second seat equipment item 20 is arranged on the other side of the central vertical plane P. The central vertical plane P passes through the middle of the backrest in the transverse direction Y. Similarly, the third seat equipment item 20 is located on one side of the central vertical plane P. The fourth seat equipment item 22 is located on the other side of the central vertical plane P.

Alternatively, the assistance system 2 comprises a different number of seat equipment items arranged on the backrest and a different number of seat equipment items arranged on the squab.

Alternatively, the assistance system 2 comprises only seat equipment items on the backrest or only seat equipment items on the squab.

Preferably, the seat equipment items 16, 18, 20, 22 comprise vibrating devices 24 shown schematically in FIG. 1.

The vibrating devices 24 comprise a support and a vibrating element which is movable relative to the support in a direction perpendicular to the support. The operating modes of the vibrating devices are characterized by a vibration frequency of the vibrating element and/or a vibration amplitude of the vibrating element and/or a vibration duration. The vibrating devices can be eccentric rotary mass vibration motors or linear vibrator micromotors. An example of a vibrating device is also disclosed in patent application FR 3 122 128 in the name of the applicant.

Alternatively or additionally, the seat equipment items 8 comprise an actuator 26 for pivoting the backrest 14 relative to the squab 12 about the articulation system 28.

Alternatively, the assistance system 2 comprises a single seat equipment item. This seat equipment item may, for example, comprise a single vibrating device capable of operating in different modes, or an actuator 26 capable of pivoting the backrest relative to the squab.

The motion detection sensors 6 comprise, for example, four capacitive sensors with interdigitated electrodes disposed on the backrest and four capacitive sensors with interdigitated electrodes on the squab. Each capacitive sensor with interdigitated electrodes comprises two coplanar comb-shaped electrodes that penetrate one another. Each electrode is connected to the controller by a conductor track. One electrode is connected to a potential of between 5 Volts and 12 Volts. The other electrode is connected to a ground.

Potential differences (or variations in capacitance) between the electrodes of the capacitive sensors with interdigitated electrodes are representative of the presence of an occupant on the seat. Variations in capacitance over time of each capacitive sensor can be used to detect a movement by the seat occupant, such as a natural, uncontrolled and unintentional reflex movement. The capacitive sensors with interdigitated electrodes are represented schematically by a rectangle in FIG. 1. Examples of capacitive sensors with interdigitated electrodes are disclosed and shown in patent applications FR 3 126 666, FR 3 126 668, FR 3 126 669 and FR 3 120 124 in the name of the applicant.

Alternatively, the assistance system comprises a single motion detection sensor.

Alternatively, the motion detection sensors 6 comprise at least one camera capable of capturing images of the interior of the passenger compartment and a processing unit comprising executable code configured to detect movement of the seat occupant from the captured images.

The controller 10 comprises a central processing unit (CPU), such as a processor or a microprocessor for example.

The controller 10 may be a programmable apparatus that uses software, an integrated circuit (ASIC), a master-slice integrated circuit (FPGA) or a part of the engine control unit (ECU) or a computer. The controller 10 is configured to perform a clock function and a counter function. The clock is designed to measure durations. The counter is designed to count events, incrementing by one value when predefined events occur.

The controller also comprises a memory storing executable code for implementing the assistance method using the assistance system. The memory of the controller 10 also comprises executable code for implementing a method for detecting the movement of a seat occupant by measuring the variation in capacitance between the electrodes of the capacitive sensors with interdigitated electrodes. Such a method is disclosed in patent application FR 3 106 094 in the name of the applicant. To this end, the controller 10 supplies voltage to one of the detection sensor electrodes. The controller 10 is also configured to control the operation of the seat equipment items and to control the modification of the operating mode of the seat equipment items.

The assistance system 2 may also comprise a speaker 30 connected to the controller 10 and/or a display screen 32 connected to the controller 10, and a communication interface 34 connected to the controller 10. The speaker 30, the display screen 32 and the communication interface 34 can be elements of the vehicle's human-machine interface. The communication interface 34 is designed for wired or wireless communication with a cell phone.

The assistance system 2 can further comprise a device 36 for determining the vehicle's driving environment and a system 38 for determining the number of passengers in the vehicle.

The device 38 for determining the vehicle's driving environment is adapted to determine whether the vehicle is driving on the freeway, in town, in heavy traffic or in light traffic. The device 36 for determining the vehicle's environment may, for example, comprise a geolocation system, a mapping system and a road traffic information system. The device for determining the driving environment may also comprise a device for measuring the vehicle's speed, one or more cameras for viewing the vehicle's environment and/or a telemetry device such as a radar, lidar or infrared light device.

The system for determining the number of passengers in the vehicle may, for example, comprise person detection sensors arranged on the seats. Alternatively, the system for determining the number of passengers may comprise a camera capable of capturing images of the interior of the passenger compartment, and a processing unit comprising executable code configured to determine the number of passengers present in the passenger compartment from the captured images.

The method for driving assistance for a vehicle according to the present disclosure can be implemented by the assistance system disclosed in connection with FIG. 1. This method monitors the driver's attention. This method enables the driver's cognitive state to be assessed.

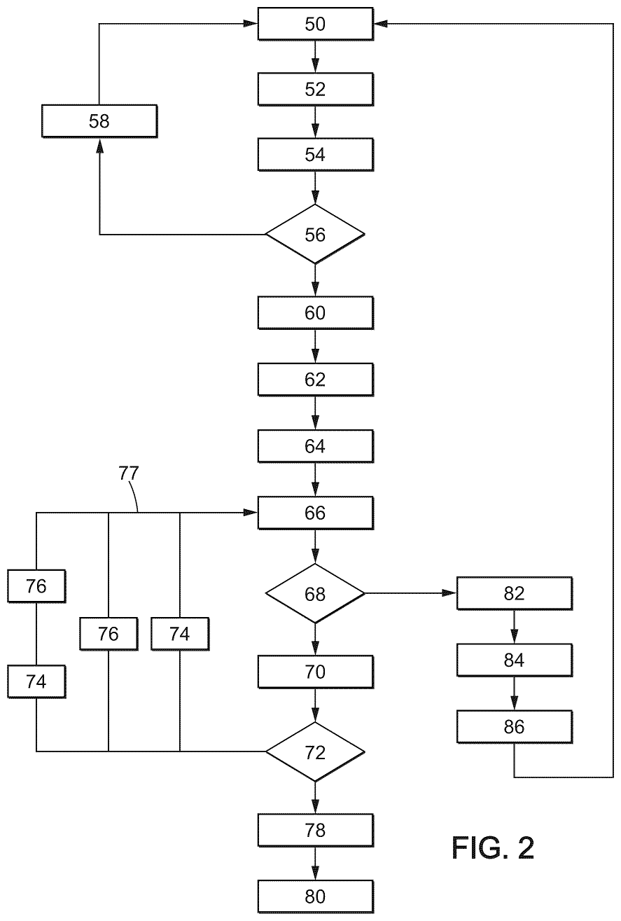

Referring to FIG. 2, the method can begin with a step 50 to determine a first defined duration D1. This determination is made based on maps stored in the controller's memory and the number of passengers determined by the determination system 38 and/or the driving environment determined by the determination device 36. For example, the first set duration D1 can be between 15 seconds and 25 seconds when the vehicle is on the freeway. The first set duration D1 can be between 5 seconds and 15 seconds when the vehicle is driving in town.

Alternatively, the first set duration D1 is predetermined and fixed regardless of the number of passengers in the vehicle or the driving environment. In this case, the first set duration D1 is stored in the memory of the controller 10 and the method begins with step 52.

In step 52, the counter is initialized. In other words, the counter is set to zero.

In a step 54, the clock is triggered.

In a step 56, the motion detection sensors determine whether the seat occupant is moving.

If the detection sensors detect any movement by the occupant of the seat 4 before the end of the first defined duration D1 (output N of step 56), the clock is stopped in a step 58 and the assistance method returns to step 50 or step 52.

If the detection sensors do not detect any movement by the occupant or only a small-amplitude movement (e.g. a small, short capacitance change) for longer than the first defined duration D1 (output N of step 56), the counter is incremented by one value and the clock is stopped, in a step 60. In the present patent application, the absence of movement by the seat occupant is defined as a stationary posture of the occupant of the seat 4. This stationary posture of the occupant of the seat 4, or a low-amplitude movement (such as a natural, uncontrolled, unintentional reflex of the occupant) that is performed during an initial phase, is referred to as the first stationary posture in this patent application.

In a step 62, the controller 10 controls the operation of at least one seat equipment item in a first operating mode.

In the example shown in FIG. 1, the controller 10 can, for example, control operation according to a first operating mode of the first vibrating device 16, which is located on one side of the central vertical plane P. The first vibrating device 16 starts vibrating at a defined frequency, at a defined amplitude and for a defined first time period corresponding to the first operating mode. For example, the vibrating element vibrates with an amplitude of 0.5 meters per square second, at a frequency of 80 Hertz, for a duration of 1 second.

Preferentially, in the first operating mode:
the vibration amplitude of the vibrating element is between 0.3 ms⁻² and 0.8 ms⁻².
the vibration frequency of the vibrating element is between 70 Hertz and 120 Hertz.
the duration of the first time period is between 0.5 seconds and 1.5 seconds.

In addition or alternatively to step 62, in a step 64, the controller 10 controls the actuator 26 so that it rotates the seat backrest relative to the seat squab through an angle of between 3% and 6% of the total angular travel of the backrest relative to the seat squab.

The aim of steps 62 and 64 is to generate a disturbance for the seat occupant. This disturbance should cause the seat occupant to move. This reactive movement is an intentional movement of medium or large amplitude, over and above a low-amplitude movement such as a natural, unintentional reflex movement. In the absence of at least a medium-amplitude movement by the seat occupant, the seat occupant is considered to be subject to a certain level of cognitive distraction.

In a step 66, the clock is triggered. This triggering takes place simultaneously with the transmission of the operating command to the first vibrating device 16 and/or the actuator 26.

In a step 68, the motion detection sensors determine whether the seat occupant is moving.

If the motion detection sensors 6 do not detect any movement of at least medium amplitude by the seat occupant for longer than a defined second duration D2, the counter is incremented by one value in a step 70. The total counter value is representative of the seat occupant's level of cognitive distraction.

The second duration D2 is, for example, between 2.5 seconds and 5 seconds.

This new stationary posture is referred to as the second stationary posture in the present patent application.

In a step 72, the counter value is compared with a threshold S. The threshold S is between 2 and 4. Preferably, the threshold S is equal to 3.

When the counter value is below the threshold S (resulting from step 72), the controller 10 controls the seat equipment item to change its operating mode in a step 74. Then, in this step 74, the controller 10 controls the operation of the seat equipment item in the modified operating mode. In the example shown in FIG. 1, the vibrating device 16 is set to a second operating mode. In the second operating mode, the vibrating element vibrates for example with an amplitude of 1.5 meters per square second, at a frequency of 60 Hertz, for a duration of 1 second.

Preferentially, in the second operating mode:
the vibration amplitude of the vibrating element is between 1 ms⁻² and 2 ms⁻².
the vibration frequency of the vibrating element is between 40 Hertz and 70 Hertz.
the duration of the second time period is between 1 second and 2.5 seconds. Alternatively or additionally, in step 76, the controller 10 controls the operation of another seat equipment item. In the example shown in FIG. 1, the controller 10 controls the operation of the second vibrating device 18. The second vibrating device 18 can be operated in the first operating mode or in the second operating mode. Note that this alternative or additional step is only implemented in embodiments wherein the assistance system comprises at least two seat equipment items.

In step 77, the method returns to step 66. The following steps are repeated. The following steps can be repeated twice or three times. In this case, with each new repetition, the operating mode of the seat equipment item(s) is modified in order to generate a greater or longer vibration which is more likely to disturb the seat occupant and generate movement by the latter in response.

When the counter value equals the threshold S (output N of step 72), the controller 10 generates an alert signal to assist the driver in a step 78. The threshold S has been defined as a limit beyond which it is considered that the seat occupant, despite the stimuli exerted by the seat equipment items, is subject to significant cognitive distractions which could endanger him while driving.

The method may also comprise a step 80 of displaying an alert message on the display screen 32 and/or broadcasting a sound alert message via the speaker 30.

If needed, the warning signal can be transmitted to the braking system so that it can slowly and automatically reduce the vehicle's speed.

If, after step 68, the motion detection sensors 6 detect a movement of the seat occupant in a step 82, and if the movement is detected within the second defined duration D2, then the clock is stopped.

Then, in a step 84, the controller 10 determines the duration D between the start of operation of the seat equipment item in step 62 and the detection of occupant movement.

When the operating mode of the seat equipment item has been modified during step 74, the controller 10 determines the duration D between the start of operation of the seat equipment item in step 74 and the detection of occupant movement.

When a second seat equipment item has been operated in step 76 and the method does not comprise step 74, the controller 10 determines the duration D between the start of operation of the seat equipment item in step 76 and the detection of occupant movement.

This duration D corresponds to the seat occupant's reaction time. This duration D is representative of the seat occupant's mental load. Generally speaking, a heavy mental load is defined as a significant demand on a person's cognitive or emotional faculties. For example, a person's mental load is often high when he is thinking about an argument.

In a step 86, the controller 10 generates an output signal representative of the determined duration D.

The method then returns to step 50 or 52, and the following method steps are repeated.

The information on the seat occupant's mental load can be used for different vehicle functions. For example, the mental load information can be used to adapt the services offered to the driver by the vehicle's human-machine interface.

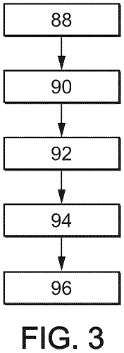

For example, with reference to FIG. 3, the method may comprise a step 88 of comparing the determined duration D with a first limit value L1 and a step 90 of modifying the display parameters of the images displayed on the display screen 32 when the determined duration D is greater than the first limit value L1. Thus, for example, the number of icons and control buttons on the display screen can be reduced. Similarly, the size of the icons and control buttons can be increased.

The first limit value L1 is, for example, between 3 seconds and 5 seconds.

For example, if during a step 92, the driver has established a wired or wireless connection between his cell phone or smartphone and the communication interface 34, and the driver receives a phone call, notification or mini-message on his cell phone, the method can comprise a step 94 of delaying the display of the mini-message on the display screen 32 and/or delaying the broadcast of an audio message by the speaker, when the predetermined duration D is greater than a second limit value L2.

The second limit value L2 is, for example, between 4 seconds and 5 seconds.

For example, the human-machine interface can communicate the mental load and/or level of cognitive distraction determined by the method to the seat occupant in order to make him aware of his condition and alert him to the fact that he may need to take a break. This communication also raises awareness of the importance of his level of concentration on the road.

To this end, the method may comprise a step 96 of displaying and/or audio broadcasting values representative of the determined durations D and/or recorded counter values. Alternatively, the method can display and/or broadcast an index representative thereof.

This step 96 can be performed at a predefined frequency. For example, this step can be performed every hour.

Alternatively, this step can be carried out at the end of driving, when the driver switches off the ignition.

Alternatively, this step can be carried out at the driver's request.

Steps 88 to 96 are optional. They can be implemented in any order.

More and more accidents are caused by momentary inattention on the part of the driver. These momentary lapses in attention are often caused by cognitive distractions. A cognitive distraction arises from an activity that uses mental attention and takes the driver's attention away from the road. For example, using a voice-activated infotainment system, listening to a phone conversation hands-free, following GPS instructions, chatting with passengers or daydreaming are cognitive distractions. Car manufacturers are looking to implement safety systems to minimize and avoid accidents caused by cognitive distractions.

However, comparative methods may use medical equipment such as electrodes. This makes them difficult to use in a vehicle. What is more, they generate false alarms.

A first aim of the present disclosure is to provide a driving assistance method for alerting the driver when he is in a state of significant cognitive distraction.

A second aim of the present disclosure is to provide a measure of the driver's mental load.

A third aim of the present disclosure is to modify the services offered by the human-machine interface when the driver's mental load is high.

The object of the present disclosure is a method for assisting the driving of a vehicle implemented by an assistance system comprising a controller, a seat, at least one sensor for detecting the movement of an occupant of the seat, and at least one seat equipment item capable of operating in a plurality of operating modes, the method comprising the following steps:
a) initializing a counter;
b) detecting a first stationary posture of the occupant for a period longer than a first defined duration;
c) incrementing the counter by one value;
d) controlling the operation of the at least one seat equipment item in an operating mode;
f) when a second stationary posture is detected for longer than a second defined duration, incrementing the counter by one value;
g) comparing the counter value with a threshold;
h) when the counter value equals the threshold, generating an alert signal to assist the driver.

Advantageously, this method warns the driver when he is experiencing a significant level of cognitive distraction, so that he can implement measures to reduce these cognitive distractions, such as stopping chatting with other passengers, turning off the radio, concentrating, etc.

The features disclosed in the following paragraphs may optionally be implemented. They can be implemented independently of one another or in combination with one another:
When the counter value is below the threshold, the method comprises the following steps:
controlling a change in the operating mode of the at least one seat equipment item and controlling the operation of the at least one seat equipment item in the changed operating mode, and
returning to step f).
The assistance system comprises a plurality of seat equipment items, and wherein when the counter value is below the threshold, the method comprises the following steps:
controlling the operation of another seat equipment item, and
returning to step f).
The at least one seat equipment item comprises at least one vibrating device comprising a support and a vibrating element movable relative to the support; and wherein the step of controlling a change in the operating mode of the vibrating device comprises changing the vibration frequency of the vibrating element and/or changing the vibration amplitude of the vibrating element and/or changing the vibration duration.

Advantageously, a vibration stimulus is an effective means of generating driver movement and mental refocusing on the driving activity.

Advantageously, this method is efficient and inexpensive.
The seat comprises a squab and a backrest hinged to the squab; and wherein the at least one seat equipment item comprises a first seat equipment item and a second seat equipment item carried by one of the backrest and squab, the first seat equipment item being disposed on one side of a central vertical plane, the second seat equipment item being disposed on the other side of the central vertical plane.
The seat comprises a squab, a backrest hinged to the squab and wherein the at least one seat equipment item comprises an actuator capable of driving the pivoting of the backrest relative to the squab, and wherein the step of controlling the operation of the at least one seat equipment item comprises a step of controlling the driving in rotation of the backrest relative to the squab through an angle of between 3% and 6% of the total angular travel of the backrest by the actuator.
The method comprises a step for determining the first defined duration based on the number of passengers in the vehicle and/or the vehicle's driving environment.
The assistance system further comprises a speaker and/or a display screen, and wherein, upon receipt of the alert signal, the method further comprises a step of displaying an alert message on the display screen and/or broadcasting an alert sound message through the speaker.

The method further comprises the following steps:
i) detecting a movement of the seat occupant after a second stationary posture is detected,
j) determining the duration between the start of operation of the at least one seat equipment item, and/or the start of operation of the other seat equipment item, and the detection of the occupant's movement;
k) generating an output signal representative of the determined duration,
l) returning to step a).

Advantageously, the determined duration D corresponds to a reaction time in relation to a stimulus. This reaction time accurately characterizes mental load according to scientific data.
The assistance system further comprises a display screen suitable for displaying images, and wherein the method further comprises a step of modifying the display parameters of the image content displayed on the display screen, when the determined duration is greater than a first limit value.
The assistance system further comprises a communication interface, a speaker and/or a display screen; the communication interface being intended to communicate with a cell phone, and wherein when the predetermined duration is greater than a second limit value, the method comprises a step of delaying the display of at least one mini-message on the display screen and/or delaying the broadcasting of at least one audio message by the speaker, the mini-message and the audio message having been received by the cell phone.
The assistance system further comprises a speaker and/or display screen, and wherein the method further comprises a step of displaying and/or audio broadcasting a value representative of the determined duration and/or counter values.

The present disclosure also relates to a system for assisting the driving of a vehicle, the system comprising a seat, at least one sensor for detecting the movement of an occupant of the seat, and at least one seat equipment item capable of operating in a plurality of operating modes and a controller (10) configured to implement the assistance method as mentioned hereinbefore.

The present disclosure relates to a method for driving assistance for a vehicle comprising the following steps:
initializing (52) a counter;
detecting (60) a first stationary posture of the occupant for a period longer than a first defined duration;
incrementing (60) the counter by one value;
controlling (62, 64) the operation of the seat equipment item in an operating mode;
when a second stationary posture is detected for longer than a second defined duration, incrementing (66) the counter by one value;
comparing (68) the counter value with a threshold;
when the counter value equals the threshold, generating (78) an alert signal to assist the driver.

1. A method for assisting the driving of a vehicle implemented by an assistance system comprising a controller, a seat, at least one sensor for detecting the movement of an occupant of the seat, and at least one seat equipment item capable of operating in a plurality of operating modes, the method comprising the following steps:
a) initializing a counter;
b) detecting a first stationary posture of the occupant for a period longer than a first defined duration;
c) incrementing the counter by one value;
d) controlling the operation of the at least one seat equipment item in an operating mode;
f) when a second stationary posture is detected for longer than a second defined duration, incrementing the counter by one value;
g) comparing the counter value with a threshold;
h) when the counter value equals the threshold, generating an alert signal to assist the driver.

2. The method of claim 1, wherein when the counter value is below the threshold, the method comprises the following steps:
controlling a change in the operating mode of the at least one seat equipment item and controlling the operation of the at least one seat equipment item in the changed operating mode, and
returning to step f).

3. The method of claim 1, wherein the assistance system comprises a plurality of seat equipment items, and wherein when the counter value is below the threshold, the method comprises the following steps:
controlling the operation of another seat equipment item, and
returning to step f).

4. The method of claim 1, wherein the at least one seat equipment item comprises at least one vibrating device comprising a support and a vibrating element movable relative to the support; and wherein the step of controlling a change in the operating mode of the vibrating device comprises changing the vibration frequency of the vibrating element and/or changing the vibration amplitude of the vibrating element and/or changing the vibration duration.

5. The method of claim 1, wherein the seat comprises a squab, a backrest hinged to the squab and wherein the at least one seat equipment item comprises an actuator capable of driving the pivoting of the backrest relative to the squab, and wherein the step of controlling the operation of the at least one seat equipment item comprises a step of controlling the driving in rotation of the backrest relative to the squab through an angle of between 3% and 6% of the total angular travel of the backrest by the actuator.

6. The method of claim 1, wherein the method further comprises the following steps:
i) detecting a movement of the seat occupant after a second stationary posture is detected,
j) determining the duration between the start of operation of the at least one seat equipment item, and/or the start of operation of the other seat equipment item, and the detection of the occupant's movement;
k) generating an output signal representative of the determined duration (D),
l) returning to step a).

7. The method of claim 6, wherein the assistance system further comprises a display screen suitable for displaying images, and wherein the method further comprises a step of modifying the display parameters of the image content displayed on the display screen, when the determined duration is greater than a first limit value.

8. The method of claim 6, wherein the assistance system further comprises a communication interface, a speaker and/or a display screen, the communication interface being intended to communicate with a cell phone, and wherein when the predetermined duration is greater than a second limit value, the method comprises a step of delaying the display of at least one mini-message on the display screen and/or delaying the broadcasting of at least one audio message by the speaker, the mini-message and the audio message having been received by the cell phone.

9. The method of claim 6, wherein the assistance system further comprises a speaker and/or display screen, and wherein the method further comprises a step of displaying and/or audio broadcasting a value representative of the determined duration and/or counter values.

10. A driving assistance system for a vehicle, the system comprising a seat, at least one sensor for detecting the movement of an occupant of the seat, and at least one seat equipment item capable of operating in a plurality of operating modes and a controller configured to implement the assistance method according to claim 1.
